(19) United States
(12) Patent Application Publication
(10) Pub. No.: US 2017/0129277 A1
(43) Pub. Date: May 11, 2017

(54) Paint Can Holder

(71) Applicant: Dominik Rogowski, Thunder Bay (CA)

(72) Inventors: Dominik Rogowski, Thunder Bay (CA); Tyler J.F. Bragnalo, Kaministiquia (CA)

(21) Appl. No.: 15/230,852

(22) Filed: Aug. 8, 2016

Related U.S. Application Data
(60) Provisional application No. 62/202,354, filed on Aug. 7, 2015.

(51) Int. Cl. B44D 3/14; B65D 25/28; B65D 25/22

(52) U.S. Cl. CPC B44D 3/14; B65D 25/22; B65D 25/2829

(57) ABSTRACT

A paint can holder for holding a cylindrical paint can has a rigid frame arranged to be secured to the paint can and a flexible strap member which is supported alongside the rigid frame at one side of the paint can. The flexible strap member is oriented such that the longitudinal direction of the flexible strap member is generally oriented in an upright direction. A hand of a user can be snugly received between the handle and the can while the horizontal orientation of the hand of the user inserted under the vertically oriented strap prevents the strap from falling off the hand of the user without requiring any portion of the paint to be hooked by the fingers or thumb of the user.

This application claims the benefit under 35 U.S.C.119(e) of U.S. provisional application Ser. No. 62/202,354, filed Aug. 7, 2015.

### FIELD OF THE INVENTION

The present invention relates to a paint can holder for attachment to a paint can to assist gripping the paint can in the hand of a user. The invention further relates to a paint can holder including a plurality of interchangeable accessories to allow a paint can to be alternately supported in a hand of a user or on various objects including ladders and scaffolds for example.

### BACKGROUND

When applying paint with a brush it is commonplace for a painter to carry a partially filled paint can in one hand and a paint brush in the other such that the paint brush can be periodically dipped into the paint can. Typically, the paint can is gripped with the fingers of the user below the can and the thumb of the user hooked onto the handle of the paint can in a lowered position of the handle at the side of the can. Prolonged holding of the can commonly results in poor circulation, stress and general discomfort to both the fingers and the thumb of the user.

Various devices have been proposed to assist in gripping cans of various configurations as described in the following documents: U.S. Pat. No. 6,394,304 by Bohne et al., U.S. Pat. No. 2,774,510 by Logan, U.S. Pat. No. 4,045,069 by Fife, US 2007/0295768 by Gringer et al., U.S. Pat. No. 5,203,471 by Widman, U.S. Pat. No. 5,582,321 by Urbanchzyk, and GB 2 231 857 by Bone. In each instance, an upright rigid handle is mounted in fixed orientation to extend along the can spaced outwardly from the can to permit the handle to be gripped in the hand of the user. In each instance, stress on the user remains in view of the user being required to grip their hand about the rigid handle.

US 2011/0315700 by MacDonald et al., discloses a paint can holder including a strap arranged to extend generally horizontally and circumferentially about part of the circumference of the can. The user supports the can by inserting their hand between the strap and the can such that the fingers must remain hooked below the bottom of the can to prevent the can from falling downwardly off the hand of the user. Although stress on the thumb is reduced as compared to the conventional manner of hooking the handle of the can with the thumb of the user, stress on the fingers remains.

### SUMMARY OF THE INVENTION

According to one aspect of the present invention there is provided a paint can holder for holding a paint can which is generally cylindrical about an upright axis, the paint can holder comprising:

a rigid frame arranged to be secured to the paint can; and

a flexible strap member which is elongate in a longitudinal direction and which is supported on the rigid frame at longitudinally spaced apart positions along the strap member;

the flexible strap member being oriented relative to the rigid frame such that the longitudinal direction of the flexible strap member is generally oriented in a direction of the upright axis of the paint can.

Preferably the flexible strap member is sized so as to snugly receive a hand of a user between the flexible strap member and the paint can. The strap member may also be adjustable in length between said longitudinally spaced apart positions along the strap member to better accommodate different users.

By providing an upright flexible strap alongside the can in a vertical orientation, a hand of a user can be snugly received between the handle and the can while the horizontal orientation of the hand of the user inserted under the vertically oriented strap prevents the strap from falling off the hand of the user without any portion of the paint can being hooked by the fingers or thumb of the user. The user can support their hand in a cupped shape about a portion of the circumference of the can with minimal or no stress on the fingers or thumb of the user.

Preferably the flexible strap member is fixed relative to the rigid frame at a first end of the flexible strap member and the flexible strap member is arranged to be slidably coupled to the rigid frame member in proximity to a second end of the flexible strap member such that the flexible strap member is slidable relative to the rigid frame between a plurality of different mounting locations along the flexible strap member.

Preferably a stop limits the sliding motion of the flexible strap member relative to the rigid frame member beyond a maximum length of the flexible strap member. The stop may comprise a pin on the rigid frame which is longitudinally slidable along a slot in the flexible strap member.

The rigid frame preferably includes an upper mount including a hook arranged to be extend downwardly through an open top end of the paint can.

The rigid frame preferably also includes a lower mount including a hook arranged to receive a depending rim at a bottom end of the paint can therein.

The rigid frame may also include an auxiliary strap member arranged to extend circumferentially about the paint can in proximity to a bottom end of the paint can.

The rigid frame may collectively comprise i) an upper mount including a hook arranged to be extend downwardly through an open top end of the paint can, ii)

a lower mount including a hook arranged to receive a depending rim at a bottom end of the paint can therein, and iii) an auxiliary strap member arranged to extend circumferentially about the paint can in proximity to a bottom end of the paint can.

In some embodiments, the rigid frame comprises i) a lower mount including a hook arranged to receive a depending rim at a bottom end of the paint can thereon, and ii) an upper mount including a threaded clamping member arranged to adjustably engage an upper rim of the paint can when the lower mount receives the depending rim of the paint can thereon such that the paint can can be clamped between the lower mount and the threaded clamping member of the upper mount. The upper mount in this instance may further comprise a hook arranged to be extend downwardly through an open top end of the paint can.

In some embodiments, the flexible strap member may be readily releasable from the rigid frame and the holder may further comprise an auxiliary mount arranged to be releasably supported on the rigid frame interchangeably with the flexible strap member in which the auxiliary mount is arranged to couple the frame to a supporting object independently of the flexible strap member. The auxiliary mount may comprises a hook arranged to be hooked onto the supporting object, or a clamp arranged to be clamped onto the supporting object.

According to a second aspect of the present invention there is provided a paint can holder for holding a paint can which is generally cylindrical about an upright axis, the paint can holder comprising:

a rigid frame arranged to be secured to the paint can;

a strap member which is elongate in a longitudinal direction and which is arranged to be releasably supported on the rigid frame so as to extend generally in a direction of the upright axis of the paint can so as to receive a hand of a user between the strap member and the paint can; and

an auxiliary mount arranged to be releasably supported on the rigid frame interchangeably with the strap member, the auxiliary mount being arranged to couple the frame to a supporting object independently of the strap member.

The auxiliary mount may comprise a hook arranged to be hooked onto the supporting object, or a clamp arranged to be clamped onto the supporting object, for example.

By providing a frame attachable to a paint can that allows further attachment of various interchangeable accessories thereon, a single frame attachment to a paint can subsequently allow the paint can to be readily transferred from a ladder or scaffold mounted position to the hand of a user for example.

Various embodiments of the invention will now be described in conjunction with the accompanying drawings in which:

### BRIEF DESCRIPTION OF THE DRAWINGS

FIG. 1 is a perspective view of the paint can holder supported on a paint can according to a first embodiment;

FIG. 2 is a side elevational view of the holder supported on a paint can according to the first embodiment of FIG. 1;

FIG. 3 is a top plan view of the holder supported on a paint can according to the first embodiment of FIG. 1;

FIG. 4 is a perspective view of the rigid frame of the paint can holder in relation to a paint can with the handle shown removed according to the first embodiment of FIG. 1;

FIG. 5 is a sectional view along the line 5-5 in FIG. 3;

FIG. 6 is an enlarged perspective view of the upper mount according to the cross section of FIG. 5;

FIG. 7 is an enlarged perspective view of the lower mount according to the cross section of FIG. 5;

FIG. 8 is a schematic representation of the paint can holder according to a second embodiment of the frame for supporting various accessories interchangeably thereon;

FIG. 9 is a perspective view of a third embodiment of the frame of the paint can holder; and

FIG. 10 is a vertical cross-section through the paint can holder according to the third embodiment of FIG. 9.

In the drawings like characters of reference indicate corresponding parts in the different figures.

### DETAILED DESCRIPTION

Referring to the accompanying figures there is illustrated a paint can holder generally indicated by reference numeral 10. The holder 10 is particularly suited for holding a conventional paint can 12 of various types.

Typically the paint can includes a cylindrical side wall 14 which is enclosed at the bottom end by a circular bottom wall 16. The circular bottom wall 16 spans horizontally across the bottom end of the side wall such that a remaining lower flange portion 18 which is generally cylindrical protrudes downwardly beyond the bottom wall in proximity to the side wall 14 to define a circular lower edge forming the bottom end of the paint can. An outer bead 20 is also formed to protrude radially outward from the bottom end of the cylindrical side wall at the junction with the bottom wall about the full circumference of the can.

At the top end of the can, a top flange 22 extends radially inward from the cylindrical side wall at a location spaced slightly below the top edge such that an upper portion of the cylindrical side wall extending upwardly above the top flange 22 defines an upper flange 24 which is generally cylindrical and terminates at a top edge which is circular and lies in a horizontal plane. An outer bead 26 is provided about the cylindrical side wall at the top end thereof adjacent the upper edge of the upper flange 24 to protrude radially outwardly similarly to the bottom outer bead.

The top end of the paint can also include a lid mounting channel 28 which is generally U-shaped so as to depend downwardly from the inner edge of the top flange 24. The inner edge of the lid mounting channel 28 defines the upper rim of the paint can which is circular about the central top opening 30 of the paint can.

A lid (not shown) is typically provided in the form of a circular plate having a peripheral tongue depending from the periphery of the plate for being snugly received within the open top of the lid mounting channel 28 to frictionally retain the lid mounted on the paint can.

Although various embodiments of the paint can holder 10 are illustrated in the accompanying figures, the common features of the various embodiments will first be described.

In each instance, the holder 10 includes a rigid frame 40 having a main body 42 which is arranged to be mounted vertically alongside the can to span the full height of the can. When the can is cylindrical about an upright central axis, the main body 42 is oriented to extend generally parallel to the upright axis. More particularly, the main body is slightly taller than the can such that a portion of the frame extends below the bottom of the paint can and an upper portion extends over the top of the paint can in the mounted position. A circumferentially oriented groove 44 is provided on an inner surface of the main body 42 which is secured against the paint can at both top and bottom ends of the main body for alignment with the bottom outer bead 20 and the top outer bead 26.

The frame 40 further includes an upper mount 46 which assists in retaining the frame relative to the top end of the can. The upper mount 46 includes a main portion 48 having an inner surface forming a horizontal shelf extending radially inward from the top end of the main body 42 for extending overtop the top end of the paint can. The depth of the upper mount 46 in the radial direction of the paint can is greater than the overall width of the cylindrical side wall and lid mounting channel 28 connected to the top end thereof in the radial direction such that an inner end of the main portion of the upper mount 46 extends over the central top opening 30 of the paint can.

A flange portion 50 of the upper mount 46 depends downwardly from the inner surface at the inner end of the main portion 48 for extending downwardly into the opening 30 of the paint can. The flange portion comprises an arcuate flange having a radius which corresponds approximately to the radius of the rim about the opening 30 of the paint can. The vertical height that the flange portion depends from the bottom surface of the main portion 48 of the upper mount is greater than an overall height of the lid mounting channel 28 of the paint can.

The frame 40 of the paint can holder further includes a lower mount 52 fixed to the bottom end of the main body 42 to assist in securing the frame relative to the bottom end of the paint can. The lower mount includes a main portion 54 having an inner surface which also forms a horizontal shelf extending radially inwardly from the frame relative to the paint can such that the radial depth of the lower mount is greater than the radial distance of the outer diameter from the cylindrical side wall of the paint can to the inner diameter of the lower flange 18 of the paint can.

In the mounted position the inner end of the lower mount is thus situated radially inwardly relative to the lower flange 18 such that an upright flange portion 56 which extends upwardly from the inner end of the main portion 44 is situated to the interior of the lower flange for hooking the lower flange relative to the main body 42 of the frame. The flange portion 56 also comprises an arcuate flange having a radius which is approximately equal to the radius of the lower flange 18 of the paint can. The height of the flange portion relative to the upper surface of the main portion of the lower mount also corresponds approximately to the height of the lower flange 18 of the paint can.

The height of the flange portion of the upper mount is much greater, for example two times, the height of the flange portion 56 of the lower mount. More specifically, the upper and lower mounts are configured such that insertion of the top end of the paint can up into the hook defined by the flange portion of the upper mount until the top end of the paint can abuts the lower surface of the main portion of the upper mount allows the lower flange 18 of the paint can to be located fully above the top end of the flange portion 56 of the lower mount to allow the paint can to be rotated into the mounted position by subsequently displacing the lower flange of the paint can into the interior of the hook defined by the flange portion 56 of the lower mount. This is accomplished by the distance between the lower surface of the main portion 48 of the upper mount to the free end of the flange portion 56 of the lower mount being greater than the height of the paint can between the upper edge and lower edge thereof.

Once inserted into the frame, the paint can is lowered relative to the frame until the flange portion 56 of the lower mount abuts the bottom wall of the can and the lower flange 18 abuts the upper surface of the main portion 54 of the lower mount in a hooked relationship. The greater length of the flange portion of the upper mount ensures that the top end remains in a hooked relationship as the lower mount is hooked relative to the can. This is accomplished by the distance from the upper surface of the main portion 54 of the lower mount to the bottom free end of the flange portion 50 of the upper mount 46 being less than the height of the paint can between the rim of the lid mounting flange 28 and the lower flange 18.

The holder 10 further includes a strap 62 in the form of an elongate flexible member for example formed of rubber or other resilient material, which is mounted in a vertical orientation alongside the rigid frame 40 for corresponding mounting in a vertical orientation alongside the paint can, parallel to the upright axis of the paint can.

An upper clamp 64 is provided for fixing the top end of the strap 62 in fixed relation to the top end of the main body 42 of the rigid frame in proximity to the upper mount 46 thereof. Similarly a lower clamp 66 is situated at the bottom end of the main body 42 of the rigid frame for securing the strap relative to the rigid frame in proximity to the lower mount 52.

Although the upper clamp is generally fixed relative to the strap in use, the lower clamp is arranged to be readily released and readily secured at different positions or mounting locations spaced apart along the length of a strap so as to permit the overall length of the strap between the upper and lower clamps to be readily adjusted.

In use, the user typically releases the lower clamp, inserts one hand in a cupped shape in the circumferential direction about the paint can between the strap and the rigid frame 40, then adjusts the length of the strap to snugly receive their hand between the strap and the rigid frame 40 alongside the paint can such that subsequent clamping of the lower clamp 66 grips the hand of the user between the strap and the paint can.

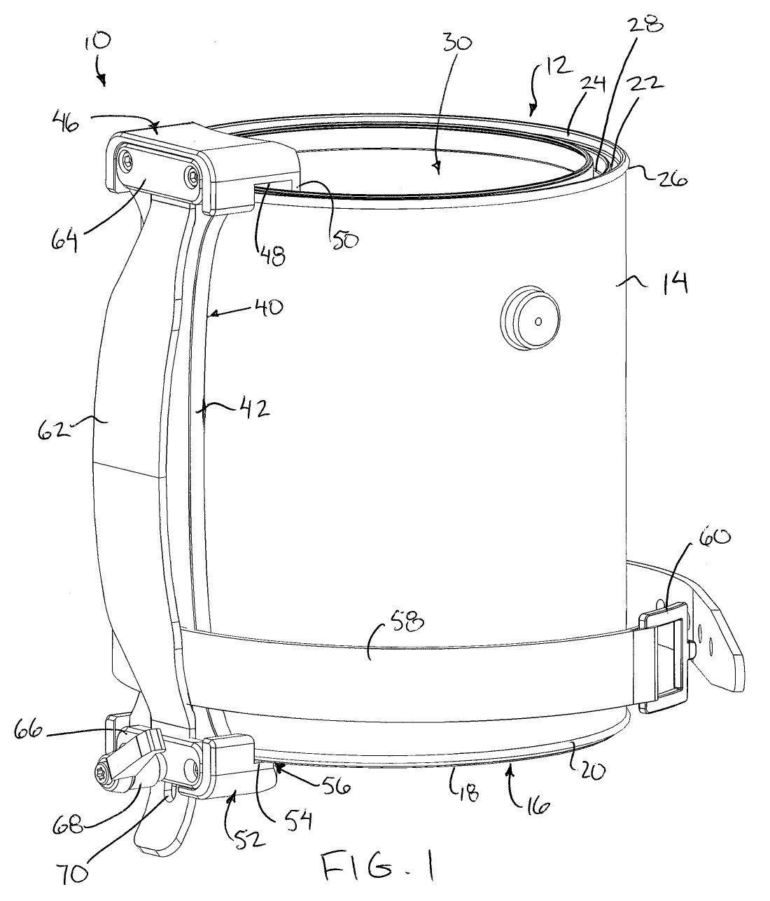

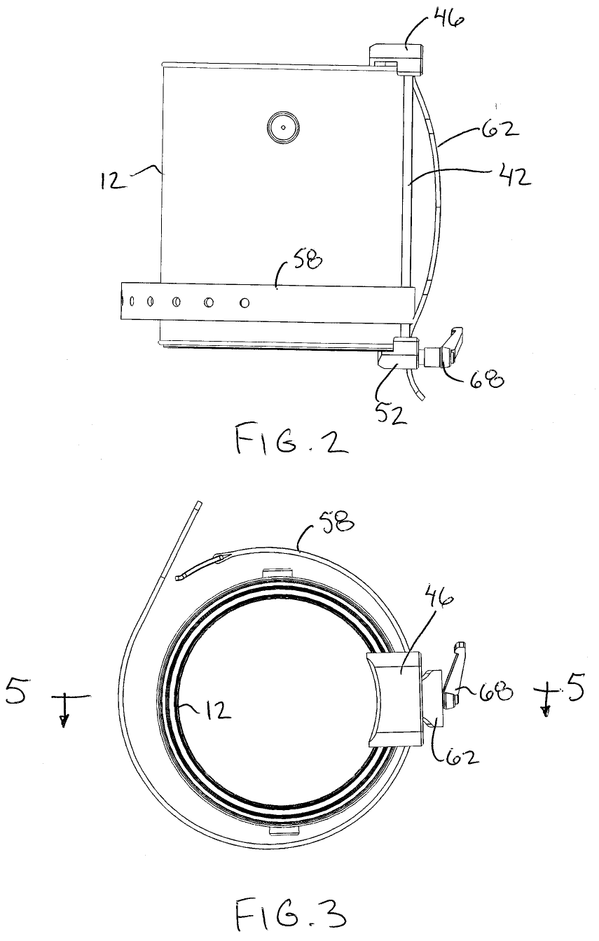

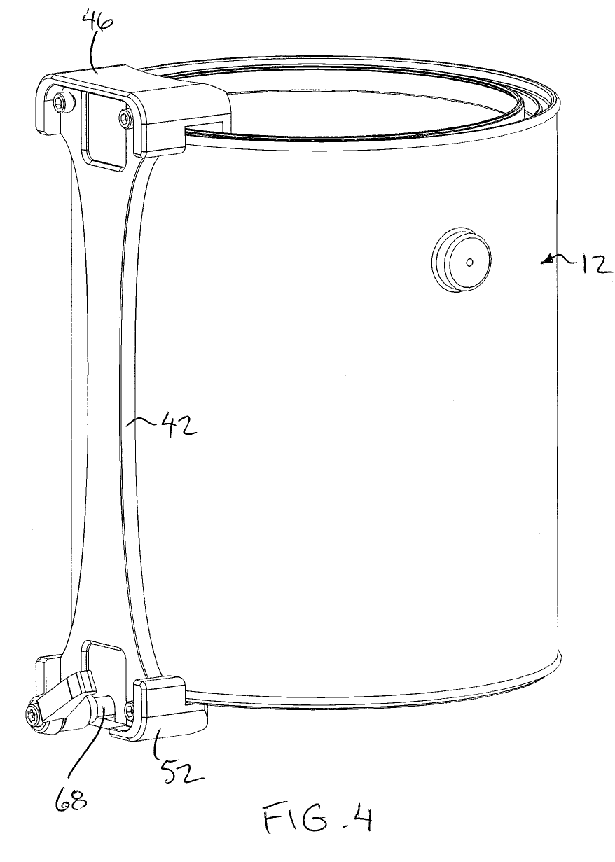

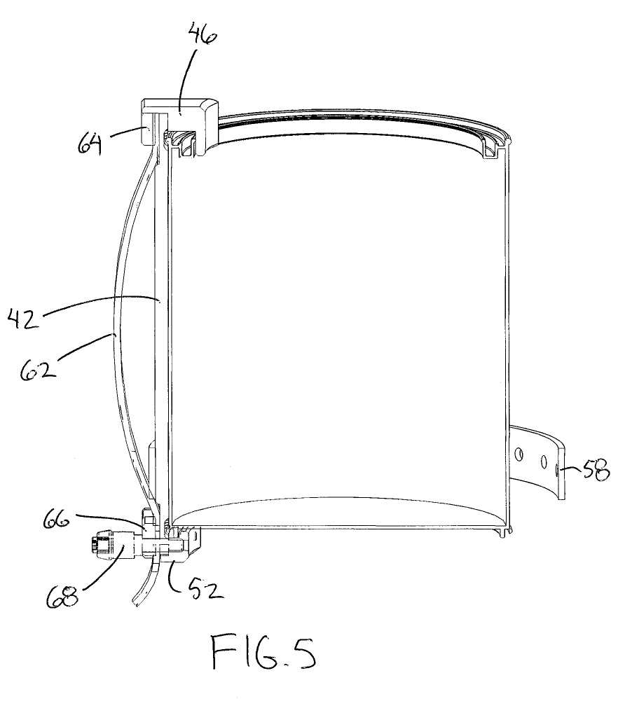

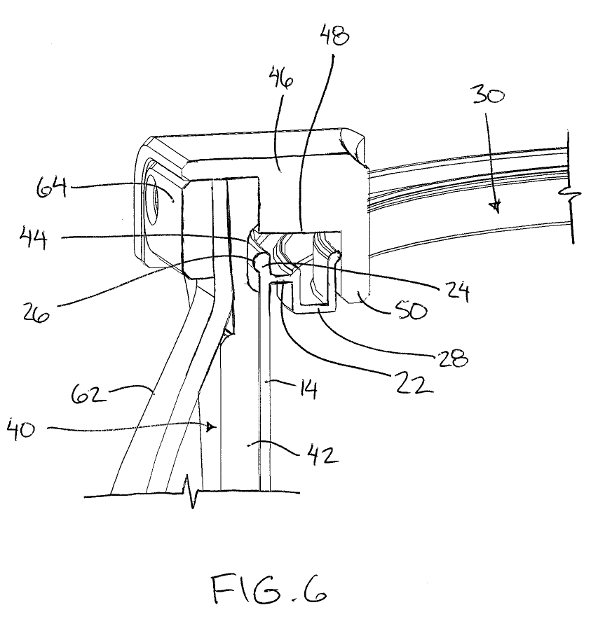

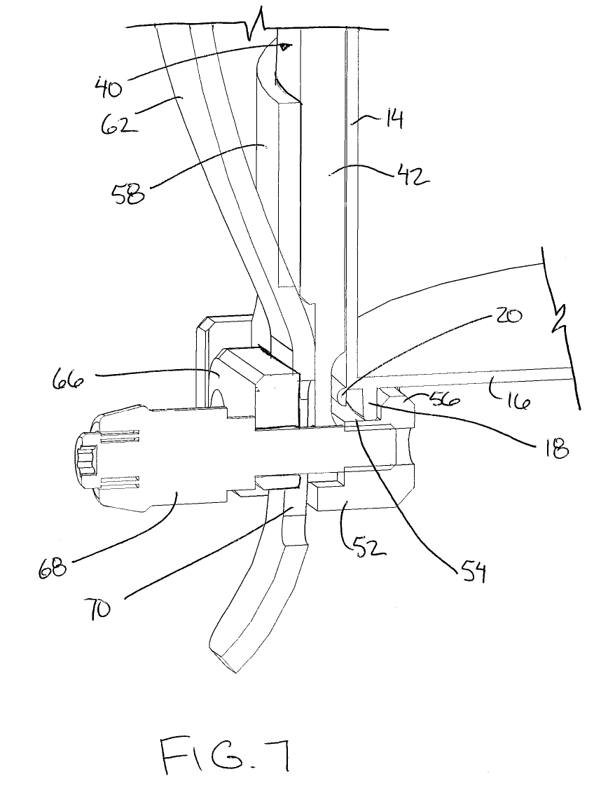

Turning now to the first embodiment of FIGS. 1 through 7, for additional securement the frame also includes an auxiliary strap 58 which is coupled to the main body of the frame at an intermediate location closer to the bottom end than the top end thereof. The strap includes two opposing ends arranged to extend in opposing circumferential directions from the main body 42 of the rigid frame to extend about the full circumference of the paint can. A suitable buckle 60 can be used to adjustably secure the two ends together at any one of a number of different circumferences to accommodate slightly different paint can configurations. The auxiliary strap 58 provides additional securement to retain the frame snugly adjacent the cylindrical side wall the of the paint can in fixed relation therewith.

In the first embodiment of FIGS. 1 to 7, the upper clamp comprises a block of rigid material which is clamped against the main body 42 using threaded fasteners which serve to clamp the top end of the strap between the upper clamp 64 and the main body of the rigid frame as the threaded fasteners are tightened.

The lower clamp 66 in this instance also comprises a block of rigid material arranged to be adjustably clamped relative to the bottom end of the main body by a suitable adjustable cam lock fastener 68. In this instance, the strap includes a longitudinally oriented slot 70 therein in alignment with the lower clamp through which the fastener 68 protrudes. In this manner the fastener 68 acts as a stop pin which is longitudinally slidably along a length of the slot 70 such that the strap is thus longitudinally slidable through the lower clamp between respective upper and lower limits of the overall length corresponding to the fastener 68 abutting opposing ends of the longitudinally oriented slot 70.

The fastener 68 is operable between a clamped position in which the bottom end of the strap is frictionally clamped and fixed between the body of the lower clamp 66 and the bottom end of the main body, and a released position in which the lower clamp is permitted to be spaced outwardly relative to the clamped position to release the frictional clamping on the strap such that the strap is freely slidable in the longitudinal direction of the strap between the body of the lower clamp and the main body of the rigid frame 40. Displacing a lever at the outer end of the cam lock fastener 68 operates the fastener between the clamped and released positions thereof. Due to the arrangement of the fastener extending through the slot 70 in the strap, even in the released configuration of the fastener, the strap is prevented from being fully withdrawn from the lower clamp to provide additional security to a user gripping the paint can.

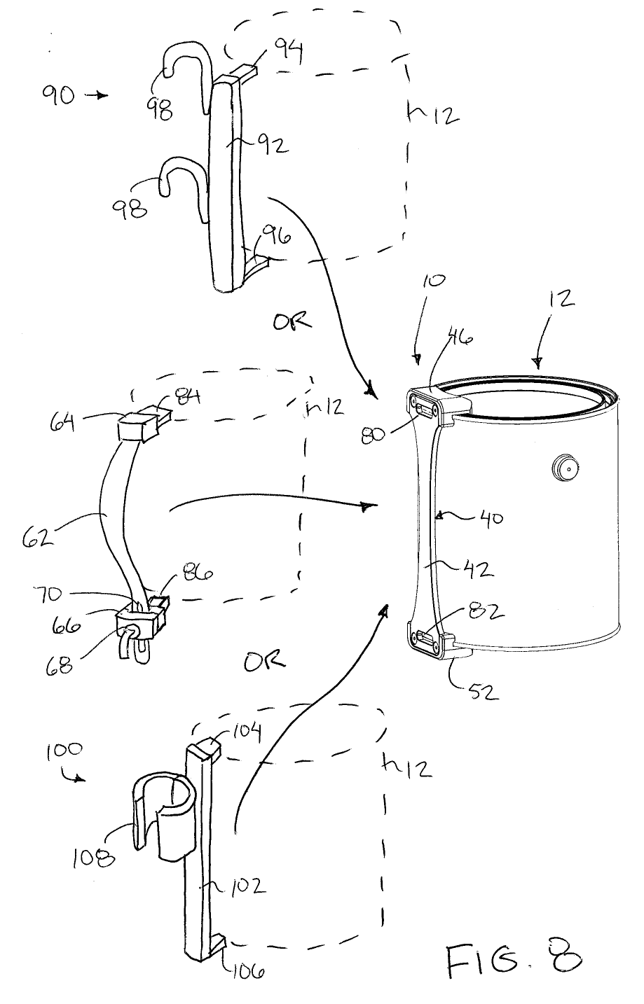

Turning now to the second embodiment shown in FIG. 8, in this instance the frame includes an upper connector 80 at the top end of the main body and a lower connector 82 at the bottom end of the main body onto which various accessories are mounted so as to be readily releasable therefrom.

The strap 62 in this instance comprises merely one of plural interchangeable accessories. The main body of the upper clamp in this instance includes a suitable connector 84 which can be quickly connected to the upper connector of the frame so as to be readily releasable as desired. Similarly, the lower clamp 66 in this instance includes a fastener which secures relative to a respective connector 86 which is in turn arranged to be coupled to the lower connector 82 of the frame to remain readily releasable therefrom. When the connectors 84 and 86 are mated with the upper and lower connectors 80 and 82 of the frame, the cam lock fastener 68 operates in the same manner as described above to selectively adjust the length of the strap alongside the frame 40 for gripping the hand of the user in a cup shaped about the circumference of the paint can.

Alternatively to the strap accessory 62, the holder may also include a hooking accessory 90 having a main body 92 locating both an upper mount 94 and a lower mount 96 thereon which are arranged to be selectively mated to the upper and lower connectors 80 and 82 of the frame to be readily releasable therefrom. The hooking accessory further includes one or two hooks 98 fixed relative to the main body 92 thereof to permit the frame to be hooked or mounted in a hanging relationship relative to various objects including scaffolds, ladders, and more particularly the rungs of ladders. The hooking accessory 90 is fully interchangeable with the strap accessory described above.

As further shown in FIG. 8 the holder may further include a clamp accessory 100 which is also interchangeable with the hooking accessory or the strap accessory. The clamp accessory 100 includes a main body 102 having an upper mount 104 and a lower mount 106 thereon which are arranged for selective connection to the upper and lower connectors 80 and 82 of the frame respectively. The main body 102 supports a clamp 108 thereon which can be readily clamped onto various frame members or posts including components of a ladder or scaffold for example.

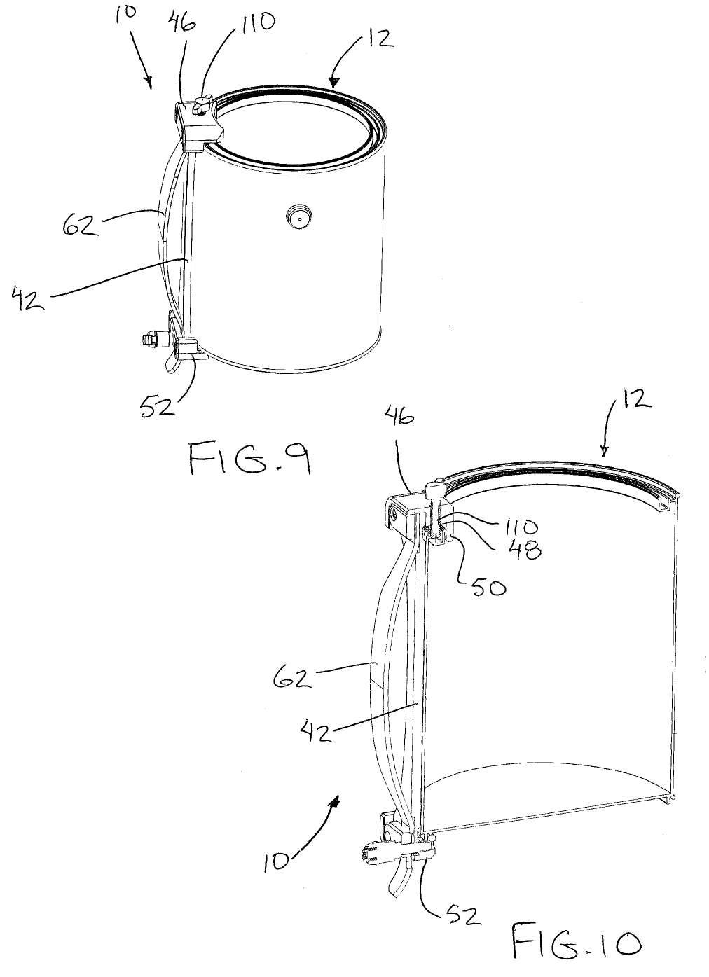

Turning now to the third embodiment of FIG. 9, the upper mount 46 further includes a threaded clamping member 110 arranged to adjustably engage the upper rim of the paint can when the lower mount 52 receives the depending rim of the paint can therein such that the paint can can be clamped between the lower mount 52 and the threaded clamping member 110 of the upper mount 46. More particularly the threaded clamping member 110 is screw threadably received in a threaded bore extending vertically through the main portion 48 of the upper mount, between the main body 42 of the frame and the depending flange portion 50 so as to protrude downwardly from the horizontal lower surface at the interior of the hook defined by the upper mount. In this instance, the upper and lower rims of the paint can are received into the hook shaped recesses of the upper and lower mounts as described above, however, the screw is then subsequently threaded downwardly into the upper mount into clamping engagement with the upper rim of the paint can within the upper mount. The threaded clamping member 110 can be sufficiently lowered within the upper mount to effectively clamp the paint can between the threaded clamping member 110 at the top side of the paint can, and the upwardly facing interior surface of the main portion 54 of the lower mount. Use of the threaded clamping member 110 eliminates the need for additional securement by an auxiliary strap member 58 as described above. The feature of the threaded clamping member 110 can be combined with other features of the first and second embodiments.

In yet further embodiments, other configurations of mounting accessories may be provided which are also interchangeable with the strap accessory 62, the hook accessory 90 or the clamp accessory 100, but which are adapted for mounting onto or being supported in relation to different types of supporting objects including ladders, scaffolds and the like.

The paint can holder 10 is readily adaptable to different size paint cans by providing different sized frames and straps as may be desired.

Since various modifications can be made in my invention as herein above described, it is intended that all matter contained in the accompanying specification shall be interpreted as illustrative only and not in a limiting sense.

1. A paint can holder for holding a paint can which is generally cylindrical about an upright axis, the paint can holder comprising:
a rigid frame arranged to be secured to the paint can; and
a flexible strap member which is elongate in a longitudinal direction and which is supported on the rigid frame at longitudinally spaced apart positions along the strap member;
the flexible strap member being oriented relative to the rigid frame such that the longitudinal direction of the flexible strap member is generally oriented in a direction of the upright axis of the paint can.

2. The paint can holder according to claim 1 wherein the flexible strap member is sized so as to snugly receive a hand of a user between the flexible strap member and the paint can.

3. The paint can holder according to claim 1 wherein the flexible strap member is adjustable in length between said longitudinally spaced apart positions along the strap member.

4. The paint can holder according to claim 1 wherein the flexible strap member is fixed relative to the rigid frame at a first end of the flexible strap member and the flexible strap member is arranged to be slidably coupled to the rigid frame member in proximity to a second end of the flexible strap member such that the flexible strap member is slidable relative to the rigid frame between a plurality of different mounting locations along the flexible strap member.

5. The paint can holder according to claim 4 wherein there is provided a stop limiting the sliding motion of the flexible strap member relative to the rigid frame member beyond a maximum length of the flexible strap member.

6. The paint can holder according to claim 5 wherein the stop comprises a pin on the rigid frame which is longitudinally slidable along a slot in the flexible strap member.

7. The paint can holder according to claim 1 wherein the rigid frame includes an upper mount including a hook arranged to be extend downwardly through an open top end of the paint can.

8. The paint can holder according to claim 1 wherein the rigid frame includes a lower mount including a hook arranged to receive a depending rim at a bottom end of the paint can therein.

9. The paint can holder according to claim 1 wherein the rigid frame includes an auxiliary strap member arranged to extend circumferentially about the paint can in proximity to a bottom end of the paint can.

10. The paint can holder according to claim 1 wherein the rigid frame further comprises:
an upper mount including a hook arranged to be extend downwardly through an open top end of the paint can;
a lower mount including a hook arranged to receive a depending rim at a bottom end of the paint can therein; and
an auxiliary strap member arranged to extend circumferentially about the paint can in proximity to a bottom end of the paint can.

11. The paint can holder according to claim 1 wherein the rigid frame further comprises:
a lower mount including a hook arranged to receive a depending rim at a bottom end of the paint can thereon; and
an upper mount including a threaded clamping member arranged to adjustably engage an upper rim of the paint can when the lower mount receives the depending rim of the paint can thereon such that the paint can can be clamped between the lower mount and the threaded clamping member of the upper mount.

12. The paint can holder according to claim 11 wherein the upper mount further comprises a hook arranged to be extend downwardly through an open top end of the paint can.

13. The paint can holder according to claim 1 wherein the flexible strap member is readily releasable from the rigid frame and wherein the holder further comprises an auxiliary mount arranged to be releasably supported on the rigid frame interchangeably with the flexible strap member, the auxiliary mount being arranged to couple the frame to a supporting object independently of the flexible strap member.

14. The paint can holder according to claim 13 wherein the auxiliary mount comprises a hook arranged to be hooked onto the supporting object.

15. The paint can holder according to claim 13 wherein the auxiliary mount comprises a clamp arranged to be clamped onto the supporting object.

16. A paint can holder for holding a paint can which is generally cylindrical about an upright axis, the paint can holder comprising:
a rigid frame arranged to be secured to the paint can;
a strap member which is elongate in a longitudinal direction and which is arranged to be releasably supported on the rigid frame so as to extend generally in a direction of the upright axis of the paint can so as to receive a hand of a user between the strap member and the paint can; and
an auxiliary mount arranged to be releasably supported on the rigid frame interchangeably with the strap member, the auxiliary mount being arranged to couple the frame to a supporting object independently of the strap member.

17. The paint can holder according to claim 16 wherein the auxiliary mount comprises a hook arranged to be hooked onto the supporting object.

18. The paint can holder according to claim 16 wherein the auxiliary mount comprises a clamp arranged to be clamped onto the supporting object.
